(19) United States
(12) Patent Application Publication
(10) Pub. No.: US 2015/0342361 A1
(43) Pub. Date: Dec. 3, 2015

(54) ELECTRIC BED ADAPTED TO WIRELESSLY RECHARGE AN ELECTRONIC DEVICE

(71) Applicant: Chuan-Hang SHIH, Lu-Kang Town (TW)

(72) Inventor: Chuan-Hang SHIH, Lu-Kang Town (TW)

(21) Appl. No.: 14/290,136

(22) Filed: May 29, 2014

(51) Int. Cl. A47C 27/14; A47G 9/02; H02J 7/02

(52) U.S. Cl. CPC A47C 27/146; H02J 7/025; A47G 9/0238

(57) ABSTRACT

An electric bed adapted to wirelessly recharge an electronic device includes a main body, a bed cover, a retainer and a wireless charger. The main body has a top surface, several side surfaces connecting to the top surface, and a cavity formed on one of the side surfaces. The bed cover covers the top surface and the side surfaces of the main body. The retainer is disposed on an outer surface of the bed cover, and the retainer is adapted to retain the electronic device at a position corresponding to the cavity. The wireless charger is disposed in the cavity and is covered by the bed cover. The wireless charger is adapted to wirelessly recharge the electronic device when the electronic device is retained by the retainer.

### BACKGROUND OF THE INVENTION

1. Field of the Invention

The present invention relates to electric bed technology and more particularly, to an electric bed adapted to wirelessly recharge an electronic device.

2. Description of the Related Art

Electric beds usually have adjustable head and foot sections. Some of the electric beds even have other functions such as music player, electric massaging device and reading light for the comfort and the entertainment of the bed. To control such operations, stationary control panels can be found on some of the electric beds. However, such stationary control panels can only be operated at predetermined positions and are sometimes inconvenient for the users. Some other electric beds are provided with remote controls using batteries. Nevertheless, the users still need to change the batteries once the power runs out.

### SUMMARY OF THE INVENTION

The present invention has been accomplished under the circumstances in view. It is the main object of the present invention to provide an electric bed adapted to wirelessly recharge an electronic device.

To achieve this and other objects of the present invention, an electric bed adapted to wirelessly recharge an electronic device includes a main body, a bed cover, a retainer and a wireless charger. The main body has a top surface, several side surfaces connecting to the top surface, and a cavity formed on one of the side surfaces. The bed cover covers the top surface and the side surfaces of the main body. The retainer is disposed on an outer surface of the bed cover, and the retainer is adapted to retain the electronic device at a position corresponding to the cavity. The wireless charger is disposed in the cavity and is covered by the bed cover. The wireless charger is adapted to wirelessly recharge the electronic device when the electronic device is retained by the retainer.

To achieve this and other objects of the present invention, an electric bed includes a main body, a bed cover, a retainer and a wireless charger. The main body has a top surface, several side surfaces connecting to the top surface, and a cavity formed on one of the side surfaces. The bed cover covers the top surface and the side surfaces of the main body. The retainer is disposed on an outer surface of the bed cover and is located at a position corresponding to the cavity. The wireless charger is disposed in the cavity and is covered by the bed cover.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a perspective view of an electric bed in accordance with a first embodiment of the present invention.

FIG. 2 is a profile of the electric bed in accordance with the first embodiment of the present invention.

FIG. 3 is a perspective view showing only a wireless charger and an electronic device wirelessly recharged by the wireless charger.

FIG. 4 is a perspective view of an electric bed in accordance with a second embodiment of the present invention.

### DETAILED DESCRIPTION OF THE INVENTION

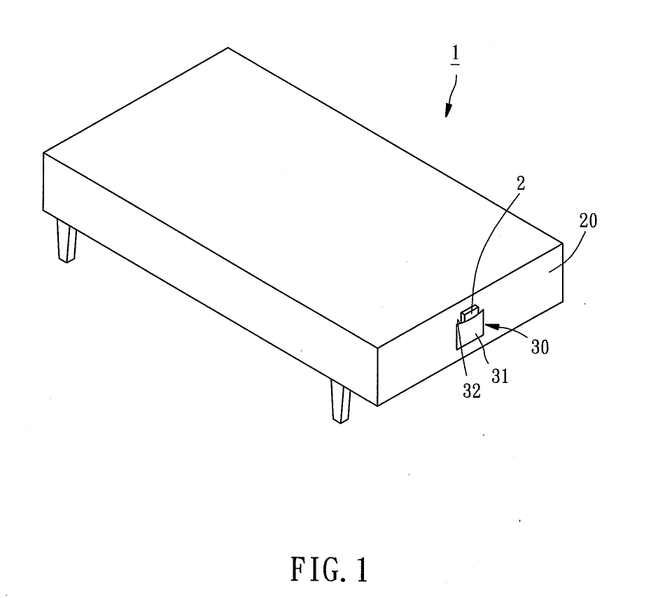

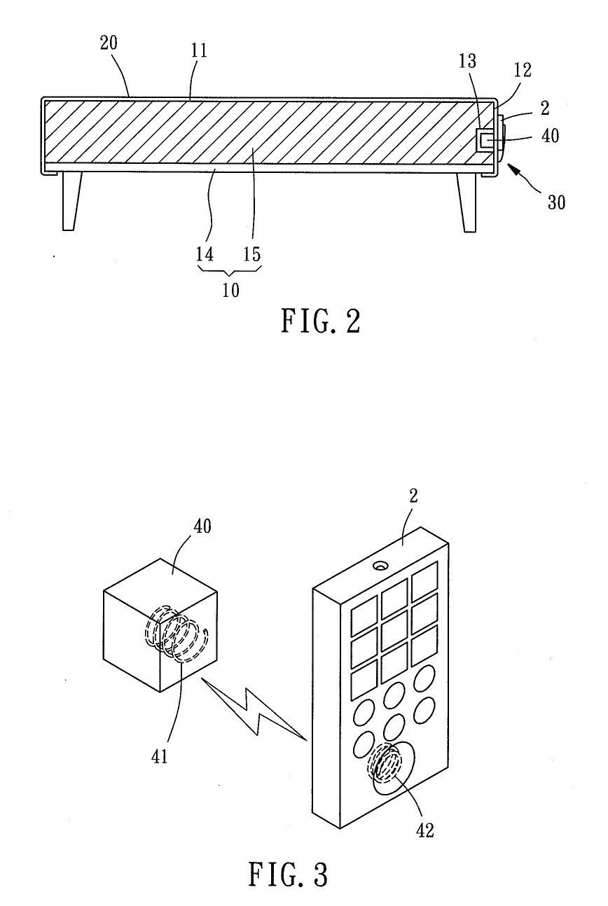

Please refer to FIGS. 1 and 2 for an electric bed in accordance with the first embodiment of the present invention. The electric bed 1 is adapted to wirelessly recharge an electronic device 2, such as a remote control as shown in FIG. 3 or a mobile phone. The electric bed 1 includes a main body 10, a bed cover 20, a retainer 30 and a wireless charger 40.

The main body 10 has a top surface 11, several (four in this embodiment) side surfaces 12 connecting to the top surface 11, and a cavity 13 formed on one of the side surfaces 12. As shown in the present embodiment, the cavity 13 can be formed on, but not limited to, a rear side surface of the main body 10. The main body 10 may include a bed frame 14 and a cushion 15 fixedly disposed on the bed frame 14, i.e. the bed frame 14 and the cushion 15 are two inseparable parts of the main body 10. The cushion 15 is usually made from resilient member, such as foamed polyurethane and other similar resins. An additional mattress (not shown) with reinforced cushioning and/or supportive characteristics is usually placed atop the cushion 15 and is an independent unit which is separable from the main body 10. Thus the mattress can be removed from the electric bed 1 when necessary. The cavity 13 can be disposed on the cushion 15. Alternatively, the cavity 13 can also be disposed on the bed frame 14 in other possible embodiments of the present invention. Nevertheless, it is noticed that the cavity 13 should not be disposed on the removable mattress, otherwise the wiring from a power source via the main body 10 to the wireless charger 40, which is designed to disposed in the cavity 13, would be a problem.

The bed cover 20 covers the top surface 11 and the side surfaces 12 of the main body 10. The bed cover 20 is preferably made of materials such as fabrics that does not substantially affect wireless transmission of the electricity.

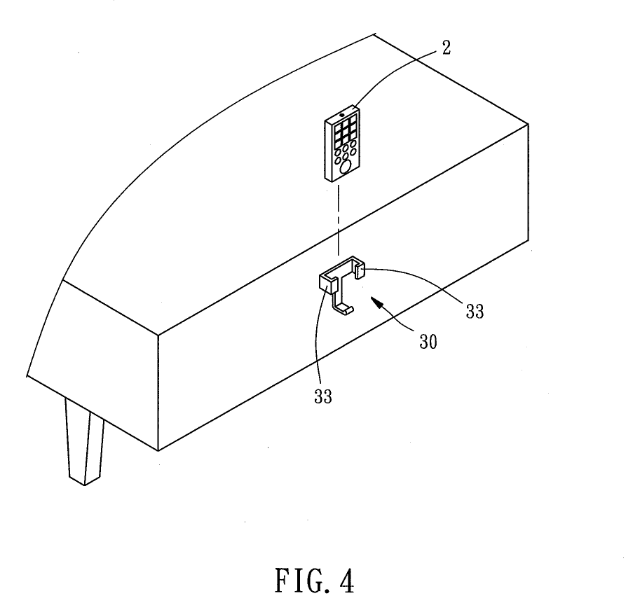

The retainer 30 is disposed on an outer surface of the bed cover 20, and the retainer 30 is adapted to retain the electronic device 2 at a position corresponding to the cavity 13. In the present embodiment, the retainer 30 is a pocket 31 having an opening 32 for insertion of the electronic device 2. Alternatively, other retaining means can also be implemented to retain the electronic device 2. For instance, the retainer 30 may include two jaws 33 for clamping the electronic device 2 therebetween as shown in FIG. 4. These jaws 33 are preferably made of plastic, and thus the jaws 33 are slightly deformable for the electronic device 2 to be easily placed between the jaws 33.

The wireless charger 40 is disposed in the cavity 13 and covered by the bed cover 20. The wireless charger 40 can be powered by a power supply such as the mains power or a battery disposed on the main body 10, and the wireless charger 40 is adapted to wirelessly recharge the electronic device 2 when the electronic device 2 is retained by the retainer 30. The term “wirelessly recharge” refers to a charging means using an electromagnetic field to transfer energy between the wireless charger 40 and the electronic device 2. Referring to FIG. 3, the wireless charger 40 has a primary coil 41 which can induce a current in a second coil 42 in the electronic device 2 when the electronic device 2 is being wirelessly recharged.

In light of the foregoing, the electric bed of the present invention can be used to wirelessly recharge electric devices such as a remote control, a mobile phone and other rechargeable devices. All the user has to do is to simply place the electric device in the retainer, which is much more convenient to the user in comparison with the conventional designs.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. An electric bed adapted to wirelessly recharge an electronic device, comprising:
a main body, having a top surface, several side surfaces connecting to the top surface, and a cavity formed on one of the side surfaces;
a bed cover, covering the top surface and the side surfaces of the main body;
a retainer, disposed on an outer surface of the bed cover, the retainer being adapted to retain the electronic device at a position corresponding to the cavity; and
a wireless charger, disposed in the cavity and covered by the bed cover, the wireless charger being adapted to wirelessly recharge the electronic device when the electronic device is retained by the retainer.

2. The electric bed of claim 1, wherein the electronic device is a remote control.

3. The electric bed of claim 1, wherein the electronic device is a mobile phone.

4. The electric bed of claim 1, wherein the retainer is a pocket having an opening for insertion of the electronic device.

5. The electric bed of claim 1, wherein the main body comprises a bed frame and a cushion fixedly disposed on the bed frame, the cavity is disposed on the cushion.

6. The electric bed of claim 1, wherein the retainer comprises two jaws for clamping the electronic device therebetween.

7. An electric bed, comprising:
a main body, having a top surface, several side surfaces connecting to the top surface, and a cavity formed on one of the side surfaces;
a bed cover, covering the top surface and the side surfaces of the main body;
a retainer, disposed on an outer surface of the bed cover and located at a position corresponding to the cavity; and
a wireless charger, disposed in the cavity and covered by the bed cover.

8. The electric bed of claim 7, wherein the retainer is a pocket having an opening.

9. The electric bed of claim 7, wherein the main body comprises a bed frame and a cushion fixedly disposed on the bed frame, the cavity is disposed on the cushion.

10. The electric bed of claim 7, wherein the retainer comprises two jaws.
